(19) United States
(12) Patent Application Publication
(10) Pub. No.: US 2019/0131806 A1
(43) Pub. Date: May 2, 2019

(54) CHARGING CORD HOLDER

(71) Applicant: Paul Caliendo, Point Pleasant, NJ (US)

(72) Inventor: Paul Caliendo, Point Pleasant, NJ (US)

(21) Appl. No.: 16/158,455

(22) Filed: Oct. 12, 2018

Related U.S. Application Data
(60) Provisional application No. 62/578,086, filed on Oct. 27, 2017.

(51) Int. Cl. H02J 7/00; H04M 1/02

(52) U.S. Cl. CPC H02J 7/0044; H04M 1/0206; H02J 7/0052

(57) ABSTRACT

A cable holder that contains a top portion, a bottom portion, and a cord in order to couple the top portion and the bottom portion, wherein the top portion includes a first member, a second member connected approximately orthogonally to the first member, and a third member connected approximately orthogonally to the second member, wherein the first member contains a first aperture; and, the bottom portion being generally “L” shaped having a long section and a short section, wherein the long section contains a second aperture, and wherein a cutout is located on the short section.

### CLAIM OF PRIORITY

This application claims priority to U.S. provisional patent application no. 62/578,086, filed Oct. 27, 2017, the entire contents of which are incorporated herein by reference.

### FIELD OF THE EMBODIMENTS

The field of embodiments of the present invention relate to a cable holder that ensures that the cable stays plugged in and charging to the cell phone or other electronic device to which it is attached.

### BACKGROUND OF THE EMBODIMENTS

As electronics get older, and as cords used to charge those electronics get more use, the mechanisms that are in place to secure the cords inside the charging ports of said electronics get worn out and no longer perform their intended jobs. Several electronics holders provide charging capability, however, as phone and other electronics get upgraded, the charging ports change and become obsolete the holders with built in chargers can be thrown out. A need exists for a phone holder that, over time, ensures that even when a phone's charging mechanism gets worn out the charging cord will still be held in place. Further a needs exists for the holder to be compatible with multiple charger types, and be used with Android, Apple, Windows, and other types of products.

U.S. Pat. No. 9,602,639 pertains to a protective arrangement for an electronic device. That includes an adapter fixedly positioned the cover and having a male plug with connectors extending into the interior cavity of the flexible cover for mating with a female socket of the device. The device can also be attached to docking cradle. This device however does not account for upgrades in phones and subsequent changes in charging cords.

U.S. App. 2016/0172883 pertains to an electronics case configured with two charging configurations whereby either a flexible cable permanently attached to the case or a receiving port accessible from the exterior of the case are selectively used. However, the external cord is not aided in any way in case the charging cord becomes old and worn out, or if a new phone requires a new plug.

None of the art described above addresses all of the issues that the present invention does. The current application provides a phone holder that ensures that as a phone's charging mechanism gets worn out the charging cord will still be held in place and will be able to function as intended and is compatible with various charger types. The current application also discloses an apparatus which helps prevent tripping on the cord by keeping the cord attached and taut, and other actions that may cause the charging cord or other cord to become disconnected from the device.

### SUMMARY OF THE EMBODIMENTS

Embodiments of the present invention include a cable holder that contains a top portion, a bottom portion, and a cord in order to couple the top portion and the bottom portion, wherein the top portion includes a first member, a second member connected approximately orthogonally to the first member, and a third member connected approximately orthogonally to the second member, wherein the first member contains a first aperture; and, the bottom portion being generally “L” shaped having a long section and a short section, wherein the long section contains a second aperture, and wherein a cutout is located on the short section.

It is an object of the embodiments of the present invention to have the first member have a width approximately equal to a length of the second member and that the first member has a length greater than the length of the second member.

It is another object of the embodiments of the present invention that the cutout extends to a connection of the long section and the short section.

It is yet another object of the embodiments of the present invention that the long section and short section are connected by a curved connection.

It is yet another object of the embodiments of the present invention that the first aperture and the second aperture are approximately of the same size and are both four sided polygons.

It is yet another object of the embodiments of the present invention that the top portion and the bottom portion are of a non-magnetic material, a plastic material, or a non-magnetic metallic material.

It is yet another object of the embodiments of the present invention that the first aperture is located at a location more than 70 percent of a length of the first member away from the connection with the second member.

It is yet another object of the embodiments of the present invention that the second aperture has a width greater than a width of the cutout.

It is yet another object of the embodiments of the present invention that cutout comprises a first section and a second section.

It is yet another object of the embodiments of the present invention that the first section includes a converging width, or that the second section includes a diverging width or both.

It is yet another object of the embodiments of the present invention that the cord is a braided elastic cord, is made of braided plastic or contains a hook and loop system.

It is yet another object of the embodiments of the present invention that the cable holder includes a top portion, a bottom portion, and a cord configured to couple the top portion and the bottom portion, wherein the top portion and the bottom portion comprise a non-magnetic metallic material; wherein the top portion comprises a first member, a second member connected approximately orthogonally to the first member, and a third member connected approximately orthogonally to the second member; wherein the first member comprises a first aperture, wherein the first aperture is located at a location more than 70 percent of a length of the first member away from a connection with the second member; the bottom portion being generally “L” shaped having a long section and a short section, wherein the long section and the short section are connected by a curved connection, wherein the long section comprises a second aperture, and wherein a cutout is located on the short section extending to the connection of the short section and the long section; wherein the cutout comprises a first section and second section, the first section includes a converging width and the second section includes a diverging width; and wherein the cord comprises a braided plastic.

It is yet another object of the embodiments of the present invention that a cable holder system includes a top portion, a bottom portion, and a cord configured to couple the top portion and the bottom portion, wherein the top portion and the bottom portion comprise a non-magnetic metallic material; wherein the top portion comprises a first member, a second member connected approximately orthogonally to the first member, and a third member connected approximately orthogonally to the second member; wherein the first member comprises a first aperture, wherein the first aperture is located at a location more than 70 percent of a length of the first member away from a connection with the second member; the bottom portion being generally “L” shaped having a long section and a short section, wherein the long section and the short section are connected by a curved connection, wherein the long section comprises a second aperture, and wherein a cutout is located on the short section extending to the connection of the short section and the long section; wherein the cutout comprises a first section and second section, the first section includes a converging width and the second section includes a diverging width; and wherein the cord comprises a braided plastic; wherein the top portion is coupled to the bottom portion by the cord, wherein a first portion of the cord is secured through the first aperture and a second portion of the cord is secured through the second aperture such that the first aperture and the short section and the second member are situated at opposing ends of the system.

The embodiments mentioned above provide a cable holder that helps ensure a cable stays plugged into a certain device and charging. The device helps ensure a phone holder that ensures that as a phone's charging mechanism gets worn out the charging cord will still be held in place and will be able to function as intended and is compatible with various charger types. The current application also discloses an apparatus which helps prevent tripping on the cord by keeping the cord attached and taught. As charging cords used for electronics get more use, the mechanisms that are in place to secure the cords inside the charging ports of said electronics get worn out and no longer perform their intended jobs. Several electronics holders provide charging capability, however, as phones and other electronics get upgraded, the charging ports change and become obsolete the holders with built in chargers can be thrown out. A need exists for a phone holder that, over time, ensures that even when a phone's charging mechanism gets worn out the charging cord will still be held in place. Further a needs exists for the holder to be compatible with multiple charger types, and be used with Android, Apple, Windows, and other types of products.

### BRIEF DESCRIPTION OF THE DRAWINGS

FIG. 1 shows a front perspective view of an embodiment of the invention.

FIG. 2 shows a side perspective view of an embodiment of the invention.

FIG. 3 shows an exploded view of an embodiment of the invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

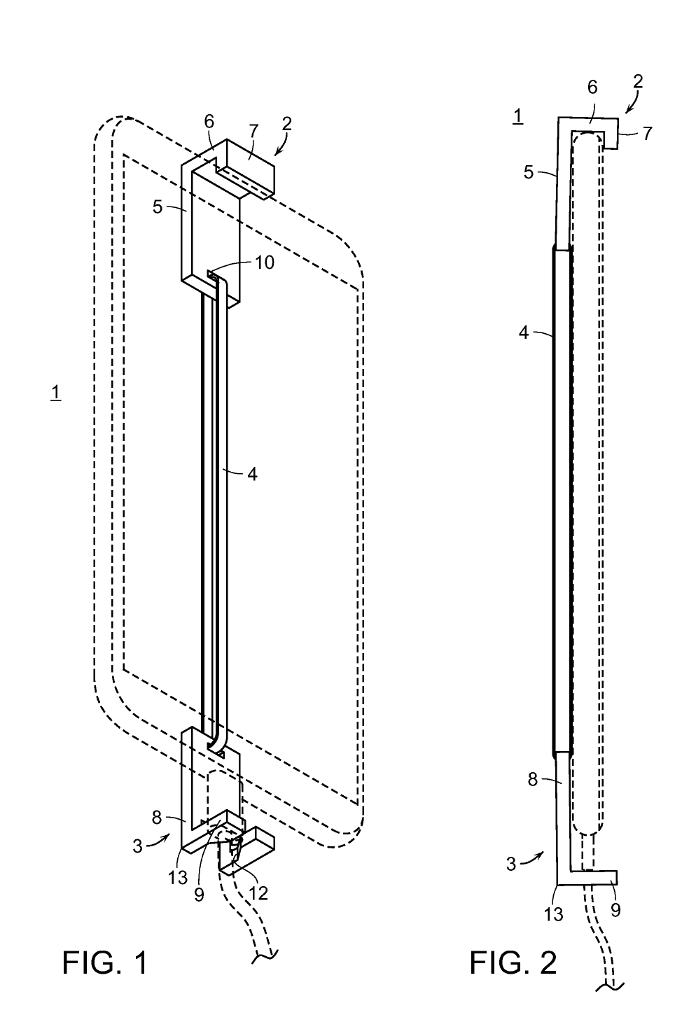

FIG. 1 shows a cable holder 1 that can be used for an electronics device that requires charging. The cable holder can include a top portion 2, a bottom portion 3, and an elongated strap 4, which can be a cord or similar material, configured to couple the top portion 2 and the bottom portion 3. The strap 4 can ensure a secure fit, while at the same time allowing for different spacing between the top portion 2 and the bottom portion 3. The strap 4 can be made of braided elastic or braided plastic. The materials and structures ensure that the cord is flexible but at the same time maintains a structure and keeps the top portion and the bottom portion in place relative to each other in order to keep the phone or other electronics in place. The strap 4 can include a hook and loop system in order to secure the cord.

Further shown in FIG. 1, the top portion 2 can include a first member 5, a second member 6 connected approximately orthogonally to the first member 5, and a third member 7 connected approximately orthogonally to the second member 6. The term “orthogonal” or “orthogonally” signifies that the angular relationship between each of the structures forming the “orthogonal” relationship is near 90 degrees. As shapes of electronics change, with smoother and sharper edges coming in and out of style, an electronics holder should be able to securely hold an electronics device with a near 90 degree angle or other angle(s) formed within several degrees plus or minus of 90 degrees. The first member can contain a first aperture 10, that can be used a coupling point with the strap 4. The first aperture 10 can be located at a point more than 70 percent of a length of the first member away from a connection with the second member 6.

As can be seen, the first member 5 can have a width approximately equal to the length of the second member 6, and the first member 5 can have a length greater than the length of the second member 6. The proportions help ensure a certain balance is achieved when a device is inserted between the top portion 2 and the bottom portion 3. The cable holder's top portion and bottom portion can include or be made wholly of plastic, a non-magnetic material, or a non-metallic magnetic material.

Also seen in FIG. 1, the bottom portion 3 can be generally “L” shaped in that the bottom portion can have a long section 8 and a short section 9 connected at approximately 90 degrees, wherein approximately defines a near 90 degree angle or other angle(s) formed within several degrees plus or minus of 90 degrees. The long 8 and short 9 sections can have a sharp 90 degree connection or be sloped or rounded. By having a non-orthogonal connection, the electronic device can be placed in any number of angles to face the user.

The long section also can contain a second aperture 11. The first aperture 10 and the second aperture 11 can be approximately of the same size or can be different sizes. The apertures can be four sided polygons of equal length, as a square or of different sized sides, as a rectangle or can be circular.

The short section 9 can include a cutout 12. The cutout 9 could allow a charging cord to pass through the holder 1 while at the same time keeping the cord secured. A portion of the cutout 12 could also extend to a connection of the long section 8 and the short section 9. The cutout can have different width sections so that a wider portion of the cord, including the plug portion, could pass through the wider portion. The charging cord could then be passed to the more narrow section, ensuring that the plug section is not able to slip out of the holder. The cutout 12 can have a narrow opening in the short section 9, with the opening widening as the opening nears the long section, eventually reaching a constant width. The constant width section can then continue into the long section 8. The opening can then start to narrow again within the long section 8. The transitions between narrowing, widening and constant width sections can be made of sharp angles or be smooth, rounded and without corners. The cutout can also vary in width vertically, becoming wider from the outside towards the inner portion of the section. The cutout can also have a zig-zagging shape. The cutout 12 allows a cord to pass through the opening and be secured into the charging slot of the electronic device while being held in place by the device. The charging cord and the phone are held in place by the top portion 2 and the bottom portion 3.

In another embodiment, the cutout 12 could be made of two sections wherein the first section includes a converging width and the second section includes a diverging width. The sections could be connected by a third, straight or rounded, section that only has enough room for a charging cord. The entire cutout or a section of the cutout should have a width smaller than the second aperture.

Also presented in FIG. 1, is a cable holder system with a specific orientation. The top portion 2 can be coupled to the bottom portion 3 by the strap 4, with a first portion 2 of the cord 4 being secured through the first aperture 10 and a second portion 11 of the strap 4 being secured through the second aperture 11 such that the first aperture 10 and the short section 9 and the second member 6 are situated at opposing ends of the system. This ensures that an electronics device and the cord is securely held between the short section 9 and second member 6.

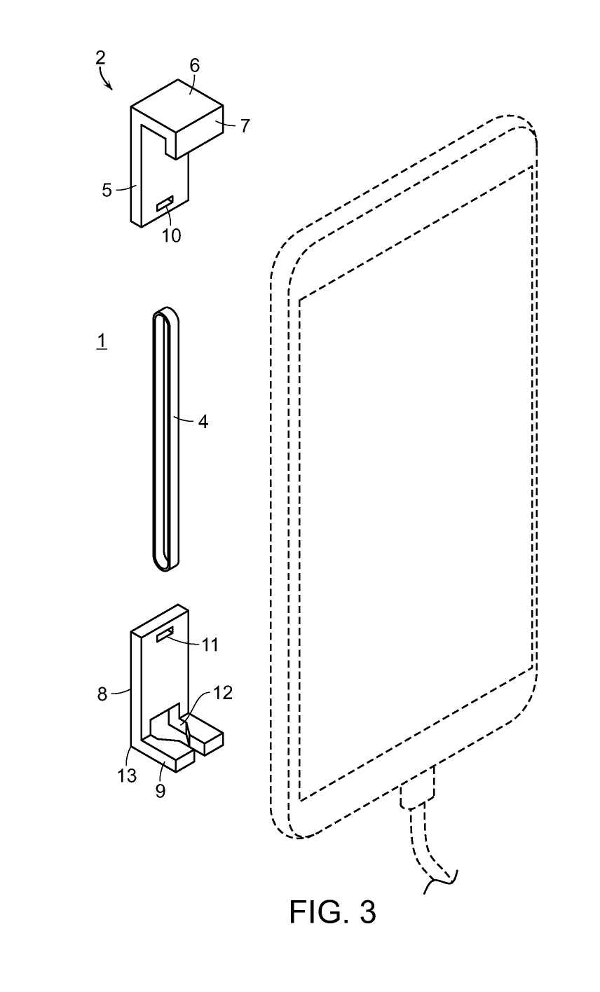

FIG. 3, shows an exploded view, of the invention. In this view a kit embodiment of the invention is seen, with the two sections, and strap being separated from each other.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A cable holder comprising: a top portion, a bottom portion, and an elongated strap configured to couple the top portion and the bottom portion, wherein the top portion comprises a first member, wherein the first member comprises a first aperture, a second member connected approximately orthogonally to the first member, and a third member connected approximately orthogonally to the second member,
and,
the bottom portion having a long section and a short section approximately orthogonal to the long section, wherein the long section contains a second aperture, and wherein a cutout is located on the short section.

2. The cable holder of claim 1, wherein the first member has a width approximately equal to a length of the second member.

3. The cable holder of claim 1, wherein the first member has a length greater than the length of the second member.

4. The cable holder of claim 1, wherein the cutout extends to a connection of the long section and the short section.

5. The cable holder of claim 1, wherein the long section and short section are connected by a curved connection.

6. The cable holder of claim 1, wherein the first aperture and the second aperture are approximately of the same size.

7. The cable holder of claim 1, wherein the first aperture and the second aperture are both four sided polygons.

8. The cable holder of claim 1, wherein the top portion and the bottom portion comprise a plastic material.

9. The cable holder of claim 1, wherein the top portion and the bottom portion comprise a non-magnetic metallic material.

10. The cable holder of claim 1, wherein the first aperture is located at a location more than 70 percent of a length of the first member away from a connection with the second member.

11. The cable holder of claim 1, wherein the second aperture has a width greater than a width of the cutout.

12. The cable holder of claim 1, wherein the cutout comprises a first section and a second section.

13. The cable holder of claim 12, wherein the first section includes a converging width.

14. The cable holder of claim 12, wherein the second section includes a diverging width.

15. The cable holder of claim 12, wherein the first section includes a converging width and the second section includes a diverging width.

16. The cable holder of claim 1, wherein the elongated strap is a braided elastic cord.

17. The cable holder of claim 1, wherein the elongated strap comprises a braided plastic.

18. The cable holder of claim 1, wherein the elongated strap includes a hook and loop system.

19. A cable holder comprising: a top portion, a bottom portion, and an elongated strap configured to couple the top portion and the bottom portion, wherein the top portion and the bottom portion comprise a non-magnetic metallic material;
wherein the top portion comprises a first member, a second member connected approximately orthogonally to the first member, and a third member connected approximately orthogonally to the second member;
wherein the first member comprises a first aperture, wherein the first aperture is located at a location more than 70 percent of a length of the first member away from a connection with the second member;
the bottom portion being generally “L” shaped having a long section and a short section, wherein the long section and the short section are connected by a curved connection, wherein the long section comprises a second aperture, and wherein a cutout is located on the short section extending to the connection of the short section and the long section;
wherein the cutout comprises a first section and a second section, the first section includes a converging width and the second section includes a diverging width; and
wherein the elongated strap comprises a braided plastic.

20. A cable holder system comprising: a top portion, a bottom portion, and an elongated strap configured to couple the top portion and the bottom portion, wherein the top portion and the bottom portion comprise a non-magnetic metallic material;
wherein the top portion comprises a first member, a second member connected approximately orthogonally to the first member, and a third member connected approximately orthogonally to the second member;
wherein the first member comprises a first aperture, wherein the first aperture is located at a location more than 70 percent of a length of the first member away from a connection with the second member;
the bottom portion being generally “L” shaped having a long section and a short section, wherein the long section and the short section are connected by a curved connection, wherein the long section comprises a second aperture, and wherein a cutout is located on the short section extending to the connection of the short section and the long section;
wherein the cutout comprises a first section and a second section, the first section includes a converging width and the second section includes a diverging width; and
wherein the elongated strap comprises a braided plastic;
wherein the top portion is coupled to the bottom portion by the elongated strap, wherein a first portion of the elongated strap is secured through the first aperture and a second portion of the elongated strap is secured through the second aperture such that the first aperture and the short section and the second member are situated at opposing ends of the system.
